(19) United States
(12) Patent Application Publication
(10) Pub. No.: US 2007/0041420 A1
(43) Pub. Date: Feb. 22, 2007

(54) Solid-state laser device

(76) Inventors: Masao Imaki, Tokyo (JP); Yoshihito Hirano, Tokyo (JP); Yasuharu Koyata, Tokyo (JP); Kouhei Teramoto, Tokyo (JP); Shigenori Shibue, Tokyo (JP)

Correspondence Address: BIRCH STEWART KOLASCH & BIRCH, PO BOX 747, FALLS CHURCH, VA, 22040-0747, US

(21) Appl. No.: 10/554,745

(22) PCT Filed: May 14, 2003
(86) PCT No.: PCT/JP03/06010

§ 371 Date: Oct. 28, 2005

(51) Int. Cl. H01S 3/10; H01S 3/091; H01S 3/08

(52) U.S. Cl. 372/99; 372/22; 372/71

(57) ABSTRACT

A solid-state laser device includes: a first solid-state laser medium 1 that emits light at a first wavelength that produces fluorescence through excitation; a second solid-state laser medium 2 that is arranged coaxially, is excited by the light at the first wavelength emitted by the first solid-state laser medium 1, and emits light at a second wavelength; two reflection means 3 and 4, which are arranged coaxially with the solid-state laser media and on both outsides of the solid-state laser media, for resonating a light component generated in an axis direction among the fluorescence; and an excitation light source 5 that excites one of the solid-state laser media, wherein the reflection means 4 has a predetermined reflectance with respect to each of the two wavelengths and laser light at the two different kinds of wavelengths is outputted separately or simultaneously with one resonator and one excitation light source.

### TECHNICAL FIELD

The present invention relates to a solid-state laser device that is applied to a display device as a light source for a projector, for instance.

### BACKGROUND ART

In general, an LD (laser diode) excitation solid-state laser includes a resonator composed of two reflectors and provided with a laser medium therein, in which light at a wavelength determined by the gain characteristic of the laser medium and the reflection characteristic of the reflectors resonates through input of excitation light into the laser medium. When the gain of the laser medium exceeds a loss in the resonator, the light is amplified and it becomes possible to extract it to the outside as an output. However, the laser light wavelength at this time is a single wavelength (see Walter Koechner, “Solid-State Laser Engineering, 4th edition”, Springer Series in Optical Sciences, Vol. 1, pp. 136, 1995, Germany, Springer-Verlag).

As described above, in the conventionally used solid-state laser device, a single laser wavelength is obtained with one resonator and one excitation light source and it is required to prepare multiple devices when it is desired to obtain multiple wavelengths. This results in a problem of an increase in apparatus size and an increase in cost.

An object of the present invention is to provide a solid-state laser device that outputs two different kinds of wavelengths separately or simultaneously with a construction including one resonator and one excitation light source.

### DISCLOSURE OF THE INVENTION

In view of the above object, the present invention provides a solid-state laser device characterized by including: one or a plurality of solid-state laser media that are arranged coaxially and produce fluorescence through excitation; first and second reflection means, which are arranged coaxially with the solid-state laser media and on both outsides of the solid-state laser media, for resonating a light component generated in an axis direction among the fluorescence; and an excitation light source that excites one of the solid-state laser media, the device being characterized in that the second reflection means has a predetermined reflectance for each of at least one wavelength.

### BRIEF DESCRIPTION OF THE DRAWINGS

FIG. 1 is a construction diagram showing a solid-state laser device according to a first embodiment of the present invention;

FIG. 2 shows a reflection characteristic of a second reflection means in a λ1 mode according to the first embodiment of the present invention;

FIG. 3 shows a reflection characteristic of the second reflection means in a λ2 mode according to the first embodiment of the present invention;

FIG. 4 is a construction diagram showing an application example of the solid-state laser device according to the first embodiment of the present invention;

FIG. 5 is a construction diagram showing a solid-state laser device according to a second embodiment of the present invention;

FIG. 6 shows a wavelength characteristic of wavelength selection means according to the second embodiment of the present invention;

FIG. 7 is a construction diagram showing a solid-state laser device according to a third embodiment of the present invention;

FIG. 8 is a construction diagram showing a solid-state laser device according to a fourth embodiment of the present invention;

FIG. 9 shows a reflection characteristic of reflection means according to the fourth embodiment of the present invention;

FIG. 10 is a construction diagram showing an application example of the solid-state laser device according to the fourth embodiment of the present invention; and

FIG. 11 shows a reflection characteristic of reflection means in FIG. 10.

### BEST MODE FOR CARRYING OUT THE INVENTION

Hereinafter, each embodiment of the present invention will be described with reference to the accompanying drawings.

### First Embodiment

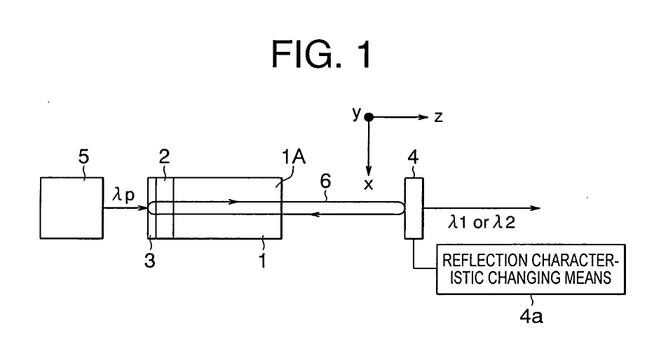

FIG. 1 is a construction diagram showing a solid-state laser device according to a first embodiment of the present invention. The solid-state laser device according to this embodiment has a basic construction including one resonator and one excitation light source and outputs two different kinds of wavelengths (λ1 and λ2) separately or simultaneously.

In the drawing, a first laser medium 1 and a second laser medium 2 are arranged coaxially so that their laser medium axis directions extend parallel to each other. A first reflection means 3 and a second reflection means 4 are arranged on an axis at both ends of the first and second laser media 1 and 2, and their incident planes are formed vertically with respect to the axis directions of the first and second laser media. A resonator is composed of the first reflection means 3 and the second reflection means 4. Hereinafter, an axis defined by the members described above will be referred to as a “resonator axis”. Note that the following description will be made by setting a direction of the resonator axis as a z-axis direction in space coordinates (leftward direction on the paper plane is positive), setting an upward direction in the space (direction vertical to the paper plane and toward the front) as a y-axis direction, and setting a direction orthogonal to the z axis and the y axis and toward a lower place of the paper plane as an x axis.

An excitation light source 5 is installed outside the resonator on the first reflection means 3 side and excites the first laser medium 1 at an oscillation wavelength λp. Resonance light 6 circulates in the resonator. Output light 7 is output light from the resonator. The first laser medium 1 has an absorption peak in the vicinity of λp and a gain peak in the vicinity of λ1. Also, a film that totally reflects light at the excitation light wavelength λp is applied to a surface 1A opposing the second reflection means 4. On the other hand, the second laser medium 2 has an absorption peak in the vicinity of λ1, has a gain peak in the vicinity of λ2, and is transparent in the vicinity of λp. The first reflection means 3 totally transmits light at the wavelength λp (reflectance=0%) and reflects 100% of light at λ1 and λ2. Note that the first reflection means 3 may be applied as a film to a surface adjacent to the second laser medium 2. Even in this case, the same effect is produced and a necessity to arrange the first reflection means 3 separately and independently can be eliminated.

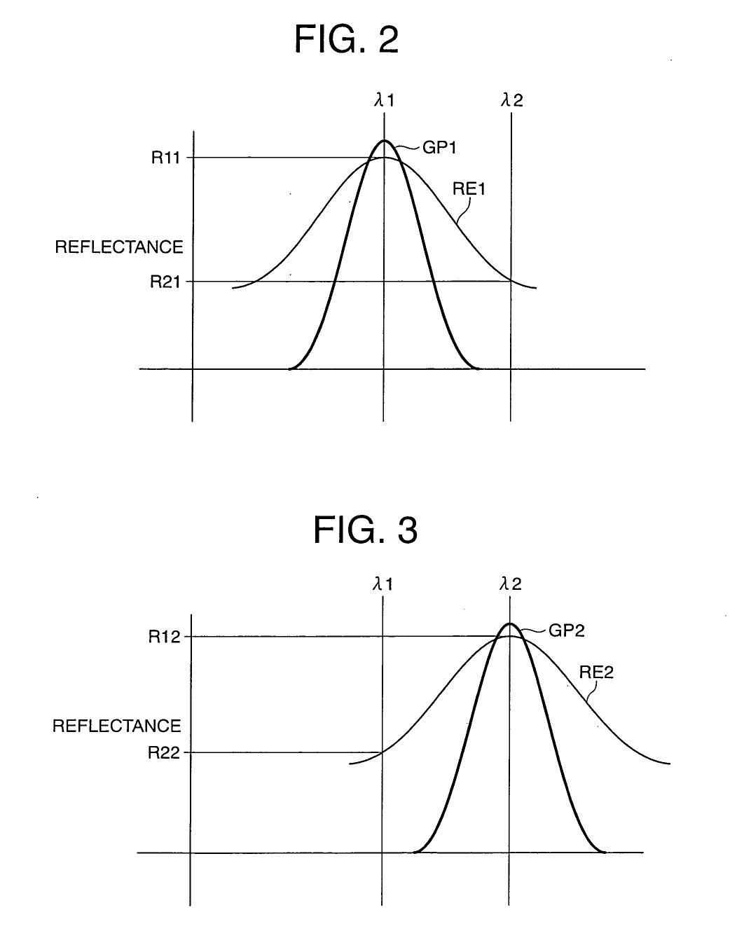

The second reflection means 4 has a two-level switching mechanism (reflection characteristic changing means 4a) that changes the reflection characteristic through external control. FIGS. 2 and 3 each show a relation between the reflection characteristic in each state and the gain peak of each laser medium. FIG. 2 relates to a λ1 mode to be described later, with GP1 indicating the gain peak of the first laser medium 1 and RE1 representing the reflection characteristic at the second reflection means 2. FIG. 3 relates to a λ2 mode to be described later, with GP2 indicating the gain peak of the second laser medium 2 and RE2 representing the reflection characteristic at the second reflection means 2. In one state shown in FIG. 2, a reflection peak with a reflectance R11 is obtained in the vicinity of a wavelength λ1, and a relatively low reflectance R21 is obtained in the vicinity of λ2 (this state will be hereinafter referred to as the “λ1 mode”). In the other state shown in FIG. 3, a reflection peak with a reflectance R22 is obtained in the vicinity of the wavelength λ2, and a relatively low reflectance R12 is obtained in the vicinity of λ1 (this state will be hereinafter referred to as the “λ2 mode”). The switching mechanism, which will be described in detail in embodiments to be described later, includes, for instance, an etalon used as the reflection means and means for switching the wavelength characteristic by tilting the reflection means, giving a voltage to the reflection means, or changing the temperature of the reflection means. The reflection characteristic changing means 4a is provided as a construction element having those functions.

Next, an operation will be described. First, an operation in the λ1 mode will be described. In this mode, only the wavelength λ1 is oscillated and oscillation of λ2 is suppressed. Excitation light is inputted from the first reflection means 3 into the resonator, passes through the second laser medium 2, and is incident on the first laser medium 1. Then, the excitation light is gradually absorbed during propagation through the first laser medium 1, is reflected by the surface 1A, and is totally absorbed into the first laser medium 1 while propagating through the first laser medium 1 again in an opposite direction. On the other hand, λ1 that is a gain wavelength is amplified by the first laser medium 1 at a gain coefficient of g1 [1/m] that is proportional to an excitation light intensity. However, a loss occurs during circulation due to the reflectance R11 at the second reflection means 4 and other losses (absorptions) α2 (absorption by the second laser medium 2 and absorption by other optical components) in the resonator, and an oscillation condition is expressed by Expression (1) given below:
2g₁L₁=2α₂−lnR₁₁ (1)
where the right side indicates the gain and the left side represents the loss. L1 denotes the length [m] of the first laser medium 1 and the coefficient 2 indicates a round-trip length. When the condition is satisfied (resonance condition), light having the length λ1 in the resonator is amplified and is oscillated. At this time, it is possible to derive a gain-loss relation also with respect to the wavelength λ2 in a like manner and it is desired to suppress the oscillation of λ2 in the λ1 mode, so Conditional Expression (2) given below is derived:
2g₂L₂<2α₁lnR₂₁ (2)
where g2 is the gain coefficient that occurs at the second laser medium 2, L2 is the length [m] of the second laser medium 2, and α1 is a loss (absorption) in the resonator with respect to λ2 occurring at the first laser medium 1 and other optical components other than R21. By selecting R11 and R21 satisfying conditions expressed by Expressions (1) and (2) given above (see FIG. 1), it becomes possible to oscillate λ1 while suppressing oscillation of λ2. Oscillation light having the oscillated λ1 wavelength is extracted from the second reflection means 4.

Next, an operation in the λ2 mode will be described. In this mode, an operation is performed in which only the wavelength λ2 is oscillated and the oscillation of λ1 is suppressed. Until the excitation light is absorbed into the first laser medium 1, completely the same operation as in the λ1 mode is performed. The excited first laser medium 1 gradually increases power in the resonator by increasing the gain of λ1. On the other hand, the second laser medium 2 emits light at the wavelength λ2 by absorbing the resonance light at the wavelength λ1. Light at the wavelength λ2 repeats stimulated emission at the second laser medium 2 and is gradually amplified in the resonator. Accordingly, the oscillation condition of λ2 is expressed by Expression (3) given below:
2g₂L₂=2α₁−lnR₂₂ (3)
The oscillation condition is not satisfied for λ1, so it is possible to cite Conditional Expression (4) given below:
2g₁L₁<2α₂−lnR₁₂ (4)
However, in order to excite the second laser medium 2, it is required to increase the power in the resonator at λ1. By selecting R22 and R12 satisfying the two expressions given above, it becomes possible to suppress the oscillation of λ1 and to oscillate λ2. The oscillation light λ2 is outputted from the second reflection means 4 like in the case of the oscillation light λ1 at the time of the λ1 mode described above.

It should be noted here that by selecting R22 and R12 satisfying Expression (5) given below in place of Expression (4) and Conditional Expression (3) given above, it becomes possible to oscillate λ1 and λ2 at the same time. Accordingly, when it is desired to extract λ1 and λ2 at the same time, this condition is satisfied.
2g₁L₁=2α₂−lnR₁₂ (5)

As described above, according to the first embodiment, a construction is achieved in which the first laser medium 1, the second laser medium 2, the first reflection means 1, and the second reflection means 4 are arranged coaxially. In this construction, it is possible to amplify also the second wavelength by exciting the first laser medium and absorbing its gain wavelength with the second laser medium, and it is also possible to oscillate two kinds of wavelengths with one resonator and one excitation light source by switching the second reflection means 4 to the two-level reflection characteristic described above.

Also, with the first laser medium 1, in both of the λ1 mode and the λ2 mode, light at the wavelength λ1 is maintained under an oscillation state or a condition close to the oscillation state, so the calorific value of the first laser medium 1 is maintained almost constant. Accordingly, the thermal lens value of the first laser medium 1 is maintained constant and also a resonator stabilized range does not change at the time of two-wavelength switching.

Further, with a reflectance of the second reflection means satisfying Expressions (3) and (5) given above at the same time, it becomes possible to output two kinds of wavelengths at the same time.

It should be noted here that as the materials of the first laser medium 1 and the second laser medium 2, for instance, it is possible to respectively cite an Nd:YAG crystal (Nd (neodymium)-atom-added Y (yttrium)-based material) and a Yb:YAG crystal (Yb (ytterbium)-atom-added Y (yttrium)-based material) (the first solid-state laser medium may be an Nd:YAG (Y₃Al₅O₁₂) crystal and the second solid-state laser medium may be a Yb:YAG crystal or the like). The Nd:YAG crystal has an absorption peak in the vicinity of 800 nm and has a gain peak at 946 nm. The Yb:YAG crystal has an absorption peak in the vicinity of 940 nm and has a gain peak at 1030 nm. Accordingly, by using an excitation light source in the vicinity of 800 nm, it becomes possible to perform two-wavelength oscillation in which λ1 corresponds to 946 nm and λ2 corresponds to 1030 nm. In addition, when excitation light at 880 nm is used, the quantum efficiency expressed by λp/λ1 becomes higher than that in the case of excitation light in the vicinity of 800 nm, so the heat generation of the first laser medium 1 is suppressed and more stability is obtained.

Also, a polarizer 8 (see FIG. 5) that is the same as that in embodiments to be described later for regulating the polarization of resonance light may be newly arranged in the resonator. It is possible to arbitrarily determine its arrangement place and the effect does not change. By arranging the polarizer, it becomes possible to form the polarized light of the outputted oscillation light as linearly polarized light. In addition, the polarizer may be installed so that its incident plane is inclined from the vertical with respect to the resonation axis. In this case, reflection light from the polarizer does not reenter the resonator axis, so it becomes possible to obtain more stabilized oscillation.

In addition, a construction is also possible in which the two-wavelength oscillation is performed without using the second laser medium 2. In this case, a construction is obtained in which the second laser medium 2 has been removed in FIG. 1. When the first laser medium 1 has multiple gain peaks or has a wide gain bandwidth, λ1 or λ2 is arbitrarily selected within the gain, and the second reflection means 4 having a reflectance satisfying the expressions described above at that time is used. At this time, both of λ1 and λ2 start to have a gain through excitation at λp, so it becomes possible to perform the two-wavelength oscillation through the reflection characteristic switching described above. For instance, by selecting an Nd:YAG crystal (Y₃Al₅O₁₂ crystal) as the material of the first laser medium 1, setting the excitation wavelength λp to 800 nm, setting λ1 to 946 nm, and setting λ2 to 1064 nm, the two-wavelength oscillation described above becomes possible. However, when one of λ1 and λ2 starts oscillation prior to the other, the gain at the other wavelength is decreased, so the two-wavelength simultaneous oscillation does not occur.

Although, as an example of the laser media described above, the combination of the Nd:YAG crystal and the Yb:YAG crystal has been described, the same effect is produced so long as the laser media are media such as Nd or Yb-added laser media and the like, which satisfy the conditional expressions described above.

Now, a second-harmonic two-wavelength oscillation solid-state laser device according to the first embodiment will be described. FIG. 2 is a construction diagram showing the second-harmonic two-wavelength oscillation solid-state laser device. A construction is obtained in which output light of the solid-state laser device in the first embodiment is wavelength-converted by a wavelength conversion element (wavelength conversion means) 70, thereby obtaining a second harmonic. By causing the output light λ1 or λ2 from the resonator to pass through the wavelength conversion element 70, a wavelength of (λ1)/2 or (λ2)/2 is obtained. The wavelength conversion element 70 uses a quasi-phase matching material simultaneously satisfying a phase matching condition with respect to two kinds of wavelengths, for instance. By using this material, it becomes possible to simultaneously output the second harmonic with respect to the two kinds of wavelengths (λ1 and λ2). As specific materials, it is possible to cite PPKTP (Periodically Poled KTiOPO₄), PPLN (Periodically Poled LiNbO₃), and MgO-added PPLN. There is a case where an ordinary non-linear material is damaged by high-power input light, while it is possible to apply PPLN to the high-power input light by increasing its temperature. In addition, it is possible to apply the MgO-added PPLN to the high-power input light even without increasing its temperature, that is, even in a room-temperature state. When the Nd:YAG crystal is used for the first laser medium 1 and the Yb:YAG crystal is used for the second laser medium 2 as described above, the wavelengths obtained from the resonator become 946 nm and 1030 nm. Accordingly, the wavelengths obtained by the wavelength conversion element 70 respectively become 473 nm and 515 nm, which results in a situation where blue laser light and green laser light are obtained. By using the Nd:YAG crystal for the first laser medium 1, using the Yb:YAG crystal for the second laser medium 2, and applying the wavelength conversion element 70 to the output light of the resonator as described above, it becomes possible to arbitrarily obtain two kinds of laser light that are blue laser light and green laser light even using a single resonator and a single excitation light source.

It should be noted here that the Nd:YAG crystal is used for the first laser medium 1 and the Yb:YAG crystal is used for the second laser medium 2, but other combinations of laser media are also applicable so long as the same effect is provided, that is, a blue second harmonic and a green second harmonic are obtained.

### Second Embodiment

A solid-state laser device according to this embodiment outputs two different kinds of wavelengths (λ1 and λ2) separately with a construction including one resonator and one excitation light source. A wavelength filter (wavelength selection means) is used as means for switching between the two wavelengths and an output coupled amount with respect to each wavelength is controlled.

FIG. 5 is a construction diagram showing the solid-state laser device according to the second embodiment of the present invention. Note that each construction element in the second embodiment that is the same as a construction element of the solid-state laser device of the first embodiment is denoted by the same reference numeral and the description of the portion will be omitted.

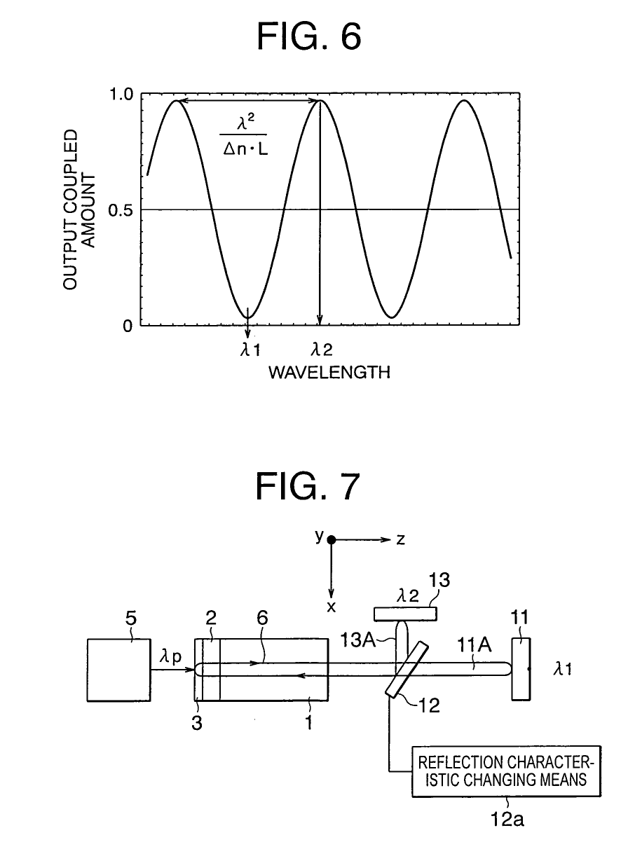

In FIG. 5, wavelength selection means 7 is arranged in the resonator. The wavelength selection means 7 includes a polarizer (polarized light selection means) 8 and polarized light rotation means 9, with the polarizer 8 being arranged so that its incident plane is inclined from the vertical with respect to the z axis by setting the y axis as a rotation center and having a characteristic in which a polarized light component (p-polarized light) vibrating in a direction parallel to an x-z plane is transmitted and an orthogonal component (s-polarized light) is reflected. The polarized light rotation means 9 is means for converting the polarized light state of incident laser light. For instance, the polarized light rotation means 9 is made of a uniaxial birefringent crystal and is formed so that its optical axis direction is inclined by 45° with respect to the x-z plane. The reflectance of the uniaxial birefringent crystal (changing rotation means 9) varies in accordance with the axis direction, so the polarized light components of the incident laser light propagate through the crystal at two mutually different kinds of phase speeds along the axis. The polarized light of laser light having passed through the crystal changes in accordance with a reflectance difference in the axis direction, the thickness of the crystal in the laser light propagation direction, and the wavelength λ. For instance, when the phase of each polarized light component has changed by ¼ of the wavelength after crystal passage, circularly polarized light is obtained. When the phase has changed by ½ of the wavelength, the angle of polarization is rotated by 90°. Generally, the birefringent crystal in the cases is respectively referred to as a “¼ wavelength plate” and a “½ wavelength plate”. By causing the output light to pass through the polarizer 8, only a polarized light component in one direction is transmitted and a polarized light component vertical thereto is reflected. However, the polarized light state depends on the wavelength as described above, so the transmission component of the polarizer 8 depends on the wavelength. The wavelength dependence corresponds to FIG. 6. A third reflection means 10 (total reflection means) assumes the same arrangement as the second reflection means 4 and has the same characteristic as the first reflection means 3.

Next, an operation will be described. Until the excitation light is absorbed into the first laser medium 1, the same operation as in the first embodiment is performed. The third reflection means 10 has the same reflection characteristic as the first reflection means 3, so without the wavelength selection means 7, light at the wavelengths λ1 and λ2 is totally reflected by the first and third reflection means and will not be outputted to the outside of the resonator. In this embodiment, a part of laser light amplified in the resonator is extracted to the outside by the wavelength selection means 7. Next, an operation of the wavelength selection means 7 will be described in detail.

Resonance light 6 circulating in the resonator passes through the polarizer 8 and therefore is regulated to p-polarized light. However, a part of the polarized light is rotated at the polarized light rotation means 9 and an s-polarized light component is generated and is extracted to the outside of the resonator by the polarizer 8. When the intensity of light incident on the polarizer 8 from a z-axis negative direction is referred to as “1”, the intensity of light extracted by the wavelength selection means 7 is expressed by Expression (6) given below:
Pt=sin²(δ/2)
:δ=(2ΠΔn·L₉)/λ (6)
where Δn is a birefringence amount, L₉ is the thickness of the polarized light rotation means 9 in the z-axis direction, and λ is the wavelength. The ratio of the intensity of the extracted light is referred to as the “output coupled amount”. In FIG. 6, an output coupled amount calculated with respect to a typical wavelength using Expression (6) is shown. As shown in FIG. 6, the output coupled amount periodically varies depending on the wavelength. The period (FSR: free spectral range) is expressed by (hat)λ2/(Δn·L). From Expression (6), by changing Δn or L (L₉ in this embodiment), it becomes possible to adjust the output coupled amount with respect to the wavelength. Therefore, when the output coupled amounts at λ1 and λ2 in the λ1 mode are respectively referred to as T11 and T21, and the output coupled amounts at λ1 and λ2 in the λ2 mode are respectively referred to as T12 and T22, an output couple condition necessary for oscillation at the time of the λ1 mode, in which only λ1 is oscillated, is expressed by Expressions (7) and (8) given below:
2g₁L₁=2α₂−ln(1−T₁₁) (7)
2g₂L₂<2α₁−ln(1−T₂₁) (8)
Also, an oscillation condition at the time of the λ2 mode is expressed by Expressions (9) and (10) given below.
2g₂L₂=2α₁−ln(1−T₂₂) (9)
2g₁L₂<2α₂−ln(1−T₁₂) (10)

It is sufficient that Δn or L is changed for the switching between λ1 and λ2. For instance, it is possible to effectively elongate L by gradually tilting the polarized light rotation means 9 with respect to the z axis (resonator axis). Alternatively, Δn may be electrically changed using the electrooptic effect of an LiNbO₃ crystal, an LiTaO₃ crystal, or the like. Also, Δn may be changed by utilizing a phenomenon that a refractive index changes in accordance with a temperature. As a function of performing the switching with the techniques, a reflection characteristic changing means 9a is provided.

It should be noted here that as to the materials of the first laser medium 1 and the second laser medium 2, the description in the embodiment described above applies in the same manner.

In addition, a construction is also possible in which the two-wavelength oscillation is performed without using the second laser medium 2. When the first laser medium 1 has multiple gain peaks or has a wide gain bandwidth, λ1 or λ2 is arbitrarily selected within the gain, and the wavelength selection means 7 having an output coupling characteristic satisfying the expressions described above at that time is used. At this time, both of λ1 and λ2 start to have a gain through excitation at λp, so it becomes possible to perform the two-wavelength oscillation through the output coupling characteristic switching described above. For instance, by selecting an Nd:YAG crystal as the material of the first laser medium 1, setting the excitation wavelength λp to 800 nm, setting λ1 to 946 nm, and setting λ2 to 1064 nm, the two-wavelength oscillation described above becomes possible. However, when one of λ1 and λ2 starts oscillation prior to the other, the gain at the other wavelength is decreased, so the two-wavelength simultaneous oscillation does not occur.

Although, as an example of the laser media described above, the combination other than the Nd:YAG crystal and the Yb:YAG crystal has been described, the same effect is produced so long as the laser media are media such as Nd or Yb-added laser media and the like, which satisfy the conditional expressions described above.

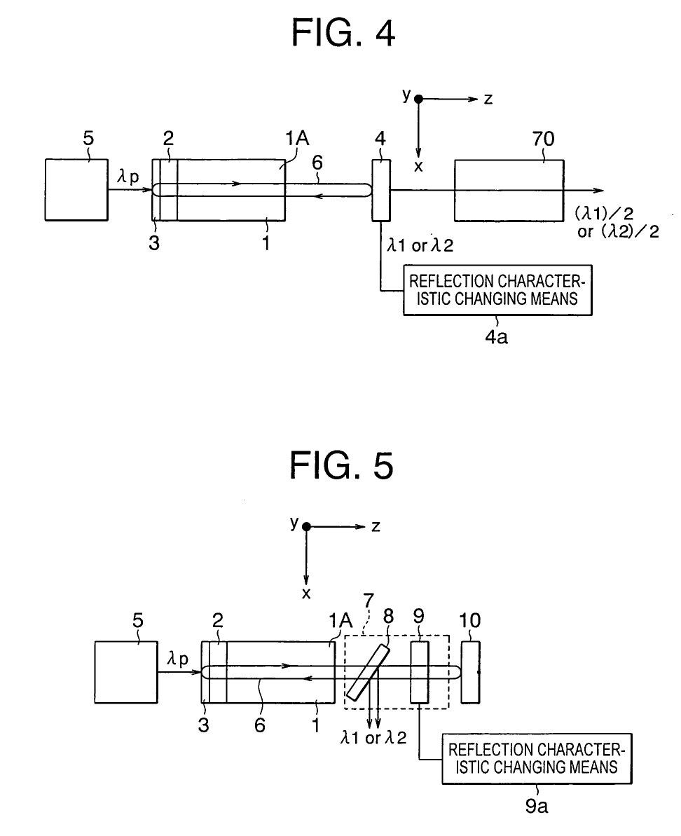

In addition, like in the description in the first embodiment described above, by providing the wavelength conversion element 70 (not shown in FIG. 5) that is the same as the wavelength conversion element shown in FIG. 4 for a laser output (the output to the outside of the polarizer 8 of FIG. 5) obtained with the construction in this embodiment, a second-harmonic two-wave-length output is obtained. The details are basically the same as those in the embodiment described above. With the construction, it becomes possible to obtain blue laser light and green laser light.

### Third Embodiment

A solid-state laser device according to this embodiment outputs two different kinds of wavelengths (λ1 and λ2) separately or simultaneously with a construction including one resonator and one excitation light source. A construction is obtained in which two wavelengths are each outputted with one excitation light source by separately using reflection means for oscillating only λ1 and reflection means for oscillating only λ2 using wavelength separation means.

FIG. 7 is a construction diagram showing the solid-state laser device according to the third embodiment of the present invention. Note that each construction element in the third embodiment that is the same as a construction element of the solid-state laser device of the first and second embodiments is denoted by the same reference numeral and the description of the portion will be omitted.

In FIG. 7, a fourth reflection means 11 assumes the same arrangement as the second reflection means 4 and the third reflection means 10. The reflection characteristic of the fourth reflection characteristic 11 satisfies a condition for oscillating only the wavelength λ1 and has a reflectance R11 satisfying Conditional Expression (1) described in the first embodiment described above. Wavelength separation means 12 has a characteristic, with which light at the wavelength λ1 is transmitted and light at the wavelength λ2 is reflected, and is arranged on the resonator axis so as to be inclined with the y axis set as a rotation axis. A fifth reflection means 13 is arranged so that its incident plane extends vertically to the reflection light axis of the wavelength separation means 12. The reflection characteristic of the fifth reflection characteristic 13 satisfies a condition for oscillating only λ2 and has a reflectance R22 satisfying Conditional Expression (3) described in the first embodiment described above. Note that the fourth reflection characteristic 11 and the fifth reflection means 13 constitute the first and second separation reflection means. Also, reflection characteristic changing means 12a for rotating the wavelength separation means 12 is provided in order to perform reflection characteristic switching.

Next, an operation will be described. Until the excitation light is absorbed into the first laser medium 1, the same operation as in the first embodiment is performed. Light at the wavelength λ1 is transmitted by the wavelength separation means 12, so an optical path passing through an optical path 11A is selected. Accordingly, the light is resonated between the fourth reflection means 11 and the first reflection means 3 and is amplified by the first laser medium 1. The fourth reflection means 11 has the reflection characteristic satisfying the oscillation condition for λ1 as described above, so laser light at λ1 is outputted to the outside. Light at the wavelength λ2 is reflected by the wavelength separation means 12, so an optical path passing through an optical path 13A is selected. Accordingly, the light is resonated between the fifth reflection means 13 and the first reflection means 3 and is amplified by the second laser medium 2 absorbed the light at the wavelength λ1. The fifth reflection means 13 has the reflection characteristic satisfying an oscillation condition for λ2 as described above, so laser light at λ2 is outputted to the outside.

It should be noted here that as to the materials of the first laser medium 1 and the second laser medium 2, the description in the embodiment described above applies in the same manner. The materials are not limited to the combination of the Nd:YAG crystal and the Yb:YAG crystal and the same effect is produced so long as the laser media are media such as Nd or Yb-added laser media, which satisfy the conditional expressions described above. In addition, a construction, in which the polarizer 8 (see FIG. 5) for regulating polarized light of resonance light is newly arranged in the resonator, is also possible like in the embodiment described above.

In addition, like in the description in the first embodiment described above, by providing the wavelength conversion element 70 (not shown in FIG. 7) that is the same as the wavelength conversion element shown in FIG. 4 for each laser output (the output to the outside of the fourth reflection characteristic 11 and the output to the outside of the fifth reflection means 13 of FIG. 7) obtained with the construction in this embodiment, the second-harmonic two-wavelength output is obtained. The details are basically the same as those in the embodiment described above. With the construction, it becomes possible to obtain blue laser light and green laser light.

### Fourth Embodiment

A solid-state laser device according to this embodiment outputs two different kinds of wavelengths (λ1 and λ2) separately or simultaneously with a construction including one resonator and one excitation light source. Wavelength switching between λ1 and λ2 is performed by electrically switching the reflection characteristic of one of the reflection means constituting the resonator.

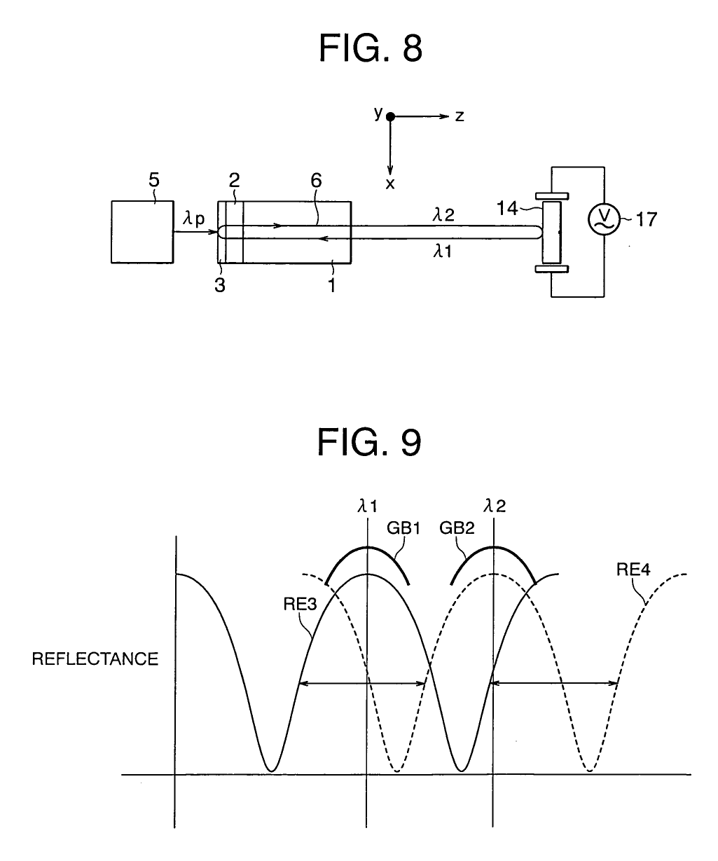

FIG. 8 is a construction diagram showing the solid-state laser device according to the fourth embodiment of the present invention. Note that each construction element in the fourth embodiment that is the same as a construction element of the solid-state laser device of the first to third embodiments is denoted by the same reference numeral and the description of the portion will be omitted.

A sixth reflection means 14 is arranged on the z axis so as to constitute a resonator together with the first reflection means 3, with a reflection coating that reflects λ1 and λ2 being applied to each of its incident plane and outgoing plane. Accordingly, the sixth reflection means 14 has wavelength dependence in its transmission/reflection characteristic due to an etalon effect, and when the reflectances on both planes are referred to as “R”, the reflectances are expressed by Expression (10) given below:
Pt={4R sin²(2nΠL/λ)}/{(1−R)²+4R sin²(2nΠL/λ)} (11)
where n is a refractive index and L is the thickness between the reflection coatings in a light propagation direction. As can be seen from the expression, the reflection/transmission characteristic periodically changes with respect to the wavelength λ. The period FSR is expressed by Expression (12) given below:
Δλ=λ²/2nL (12)
Accordingly, it is possible to freely set the reflection characteristic by changing the refractive index n or the thickness L. A crystal having an electrooptic effect is used as the material and it is possible to apply an LN crystal (LiNbO₃ crystal), an LT crystal (LiTaO₃ crystal), or the like. The electrooptic effect is an effect that a refractive index changes through application of an electric field from the outside by an electric field application means 17 composed of an AC power supply as shown in FIG. 8 or the like. In this embodiment, a setting is made so that an electric field is applied in the x-axis direction as shown in FIG. 8 and resonance light also has polarized light that vibrates in the x-axis direction. At this time, a refractive index change Δn exerted on the resonance light passing through the sixth reflection means 14 is expressed by Expression (13):
Δn=−(½)rn³E (13)
where r is an electrooptic constant, n is the refractive index, and E is the electric field. Accordingly, by using a crystal having an electrooptic effect for the sixth reflection means 14, it becomes possible to change the refractive index, that is, the reflection characteristic electrically (through application of an electric field). In FIG. 9, the reflection characteristic of the sixth reflection means 14 in this embodiment is shown. In FIG. 9, RE3 (solid line) indicates the reflection characteristic of the sixth reflection means 14 in the λ1 mode and RE4 (broken line) represents the reflection characteristic thereof in the λ2 mode. In the λ1 mode, the reflectances at the wavelengths λ1 and λ2 satisfy Conditional Expressions (1) and (2). Also, in the λ2 mode, the reflectances at the wavelengths λ1 and λ2 satisfy Conditional Expressions (3) and (4). By turning ON-OFF the electric field applied to the sixth reflection means 14, switching between RE3 and RE4 is performed. Also, GB1 and GB2 respectively indicate the gain bandwidth of the first laser medium 1 and the gain bandwidth of the second laser medium 2.

Next, an operation will be described. Until the excitation light is absorbed into the first laser medium 1, the same operation as in the first embodiment is performed. In the λ1 mode, the sixth reflection means 14 has the reflection characteristic that is RE3 in FIG. 9, so the resonator internal power at the wavelength λ1 is increased and reaches oscillation. The oscillation at λ2 is suppressed because λ2 satisfies the condition expressed by Expression (4). In the λ2 mode, the sixth reflection means 14 has the reflection characteristic that is RE4 in FIG. 9, so the resonator internal power at the wavelength λ2 is increased and reaches oscillation. The resonator internal power at λ1 is also increased, but the oscillation condition is not satisfied, so the oscillation at λ1 is suppressed.

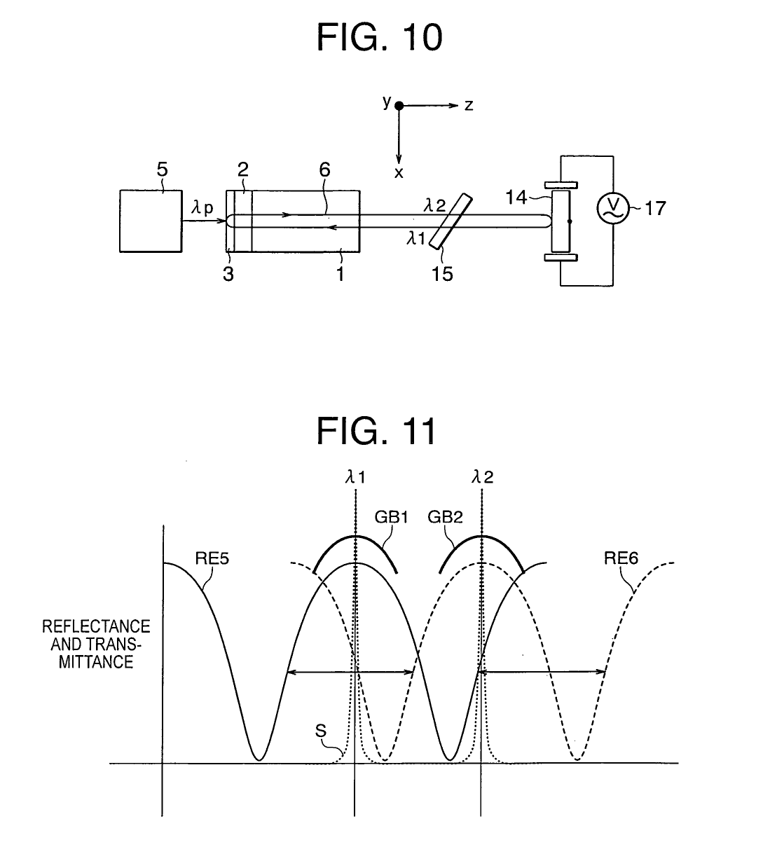

It should be noted here that for further oscillation wavelength selection, a wavelength selection element may be newly arranged in the resonator. In FIG. 10, a construction diagram, in which a wavelength selection element 15 is arranged, is shown. The wavelength selection element 15 has a wavelength characteristic with which it transmits 100% of only light at the wavelengths λ1 and λ2 and totally reflects light at other wavelengths in the vicinity of the gain bandwidths of the first laser medium 1 and the second laser medium 2. Also, a construction is obtained in which the wavelength selection element 15 is installed so that its incident plane and outgoing plane are inclined from the vertical with respect to the resonator axis (z axis) with the y axis set as a rotation center and therefore light at wavelengths other than λ1 and λ2 will not reenter the resonator axis and will not be oscillated. Further, FIG. 11 shows the reflection characteristics RE5 and RE6 of the sixth reflection means 14, the gain bandwidths GB1 and GB2 of the respective laser media, and the transmission characteristic S of the wavelength selection element 15 at the time when the construction shown in FIG. 10 is adopted. In the λ1 mode, when the wavelength selection element 15 is not provided, oscillation is performed at a wavelength in the gain bandwidth of the first laser medium 1 at which the loss becomes minimum, although the wavelength selection element 15 is provided, so light at wavelengths other than the wavelength λ1 does not circulate in the resonator and the oscillation wavelength is regulated to λ1. In a like manner, in the λ2 mode, the oscillation wavelength is regulated to λ2.

As described above, according to the fourth embodiment, an etalon material having an electrooptic effect is used for the reflection means of the resonator, so it becomes possible to switch the oscillation wavelength between two types (λ1 and λ2). Also, the switching with the construction in this embodiment electrically changes the reflection characteristic, so there will not occur problems such as an optical axis displacement of the resonator, while high-speed switching becomes possible.

Also, the wavelength selection element is arranged in the resonator, so it becomes possible to arbitrarily and strictly set the oscillation wavelength along the transmission characteristic of the wavelength selection element.

Further, a construction is also possible in which two-wavelength oscillation is performed without using the second laser medium 2. When the first laser medium 1 has multiple gain peaks or has a wide gain bandwidth, λ1 or λ2 is arbitrarily selected in the gain and the sixth reflection means 14 having a reflectance satisfying the expressions described above at that time is used for construction. The details are basically the same as those in the case of the embodiments described above.

Further, as to the materials of the first laser medium 1 and the second laser medium 2, the description in the embodiment described above applies in the same manner. In addition, a construction, in which the polarizer 8 (see FIG. 5) for regulating polarized light of resonance light is newly arranged in the resonator, is also possible like in the embodiment described above.

In addition, like in the description in the first embodiment described above, by providing the wavelength conversion element 70 (not shown in FIGS. 8 and 10) that is the same as the wavelength conversion element shown in FIG. 4 for each laser output (the output to the outside of the sixth reflection characteristic 14 of FIGS. 8 and 10) obtained with the construction in this embodiment, the second-harmonic two-wavelength output is obtained. The details are basically the same as those in the embodiment described above. With the construction, it becomes possible to obtain blue laser light and green laser light.

### INDUSTRIAL APPLICABILITY

According to the present invention, a solid-state laser device is provided which outputs laser light at two different kinds of wavelengths separately or simultaneously with a construction including one resonator and one excitation light source. As a result, a size reduction and a cost reduction are achieved. In addition, blue laser and green laser are obtained through wavelength conversion of the laser light.

1. A solid-state laser device comprising:
one or a plurality of solid-state laser media that are arranged coaxially and produce fluorescence through excitation;
first and second reflection means, which are arranged coaxially with the solid-state laser media and on both outsides of the solid-state laser media, for resonating a light component generated in an axis direction among the fluorescence; and
an excitation light source that excites one of the solid-state laser media,
the device being characterized in that the second reflection means has a predetermined reflectance for each of at least one wavelength.

2. The solid-state laser device according to claim 1, wherein the second reflection means has a first reflection characteristic, with which an oscillation condition is satisfied with respect to a first wavelength and is not satisfied with respect to a second wavelength, and a second reflection characteristic, with which the oscillation condition is satisfied with respect to the second wavelength and is not satisfied with respect to the first wavelength, and includes reflection characteristic changing means for performing arbitrary switching between the first reflection characteristic and the second reflection characteristic.

3. The solid-state laser device according to claim 1, wherein the solid-state laser media includes a first solid-state laser medium that is excited by the excitation light source and emits light at a first wavelength and a second solid-state laser medium that is excited by the light at the first wavelength emitted by the first solid-state laser medium and emits light at a second wavelength.

4. The solid-state laser device according to claim 1, wherein the solid-state laser media includes one solid-state laser medium that is excited by the excitation light source and emits light at a first wavelength and a second wavelength.

5. The solid-state laser device according to claim 2, wherein the second reflection means includes:
polarized light rotation means, which is arranged coaxially with the solid-state laser media, for arbitrarily rotating polarized light with respect to each of the first wavelength and the second wavelength;
polarized light selection means, which is arranged coaxially between the polarized light rotation means and the solid-state laser media, for transmitting a predetermined polarized light component and reflecting a polarized light component that vibrates vertically to the predetermined polarized light; and
total reflection means, which is arranged coaxially outside the polarized light rotation means and the polarized light selection means, for totally reflecting light at the first wavelength and light at the second wavelength.

6. The solid-state laser device according to claim 5, wherein the device comprising reflection characteristic changing means for changing a length in an axis direction of the polarized light rotation means or a refractive index thereof.

7. The solid-state laser device according to claim 5, wherein the polarized light rotation means rotates about an axis that is vertical to a plane defined by axes of the solid-state laser media and a plane of polarization of resonance light.

8. The solid-state laser device according to claim 6, wherein the reflection characteristic changing means changes the refractive index by changing a temperature of the polarized light rotation means.

9. The solid-state laser device according to claim 1, wherein the second reflection means includes:
wavelength separation means that is arranged coaxially with the solid-state laser media and has a characteristic with which light at a first wavelength is transmitted and light at a second wavelength is reflected;
a first separation reflection means that is arranged outside the wavelength separation means and has a predetermined reflectance with respect to the first wavelength; and
a second separation reflection means that is arranged on an optical axis, through which the light at the second wavelength reflected from the wavelength separation means passes, and has a predetermined reflectance with respect to the second wavelength.

10. The solid-state laser device according to claim 9, wherein the device comprising reflection characteristic changing means for rotating the wavelength separation means.

11. The solid-state laser device according to claim 1, wherein the second reflection means is made of a material having an electrooptic effect which is made of an etalon crystal to which a light reflection plane that reflects light to two planes vertical to axes of the solid-state laser media has been applied, and further includes an electric field application means for changing a reflection characteristic by applying an electric field to the etalon crystal.

12. The solid-state laser device according to claim 11, wherein the second reflection means has a first reflection characteristic, with which when the electric field is not applied, an oscillation condition is satisfied with respect to a first wavelength and is not satisfied with respect to a second wavelength, and has a second reflection characteristic with which when the electric field is applied, the oscillation condition is satisfied with respect to the second wavelength and is not satisfied with respect to the first wavelength.

13. The solid-state laser device according to claim 1, wherein
the second reflection means is made of a material having an electrooptic effect which is made of an etalon crystal to which a light reflection plane that reflects light to two planes vertical to axes of the solid-state laser media has been applied, and further includes an electric field application means for changing a reflection characteristic by applying an electric field to the etalon crystal; and
the solid-state laser device further comprises a wavelength selection element that is arranged coaxially between the second reflection means and the solid-state laser media and transmits light at a first wavelength and light at a second wavelength to be resonated.

14. The solid-state laser device according to claim 13, wherein the second reflection means has a first reflection characteristic, with which when the electric field is not applied, an oscillation condition is satisfied with respect to the first wavelength and is not satisfied with respect to the second wavelength, and has a second reflection characteristic with which when the electric field is applied, the oscillation condition is satisfied with respect to the second wavelength and is not satisfied with respect to the first wavelength.

15. The solid-state laser device according to claim 13, wherein the wavelength selection element is installed so that an incident plane and outgoing plane thereof are inclined with respect to axes of the solid-state laser media.

16. The solid-state laser device according to claim 3, wherein the first solid-state laser medium is an Nd (neodymium)-atom-added Y (yttrium)-based material and the second solid-state laser medium is a Yb (ytterbium)-atom-added Y (yttrium)-based material.

17. The solid-state laser device according to claim 3, wherein the first solid-state laser medium is an Nd:YAG (Y₃Al₅O₁₂) crystal and the second solid-state laser medium is a Yb:YAG crystal.

18. The solid-state laser device according to claim 4, wherein the solid-state laser medium is an Nd:YAG (Y₃Al₅O₁₂) crystal.

19. The solid-state laser device according to claim 1, wherein the device comprising wavelength conversion means, which is arranged coaxially outside the second reflection means, for converting wavelengths of laser light at first and second wavelengths extracted from the second reflection means through oscillation into wavelengths of harmonics,
the device being characterized in that blue laser light and green laser light are generated.

20. The solid-state laser device according to claim 19, wherein the wavelength conversion means is a quasi-phase matching material that satisfies a phase matching condition with respect to a plurality of wavelengths at the same time.
